(19) United States
(12) Patent Application Publication
(10) Pub. No.: US 2007/0079768 A1
(43) Pub. Date: Apr. 12, 2007

(54) Clam shell buckle apparatus

(75) Inventor: Claudio Martinez, Huntington Beach, CA (US)

Correspondence Address: FULWIDER PATTON LEE & UTECHT, LLP, 200 OCEANGATE, SUITE 1550, LONG BEACH, CA, 90802, US

(73) Assignee: Pet Buckles

(21) Appl. No.: 11/246,422

(22) Filed: Oct. 7, 2005

(51) Int. Cl. A01K 27/00

(52) U.S. Cl. 119/863

(57) ABSTRACT

A clam shell buckle including an elongated base and cover plate, pivotally connected together at one extremity to be selectively pivoted from a closed to an open position. The cover includes on its free end a depending capture pin to engage a base in the free end of a strip anchored on its opposite end to the base.

### BACKGROUND OF THE INVENTION

1. Field of the Invention

The present invention relates generally to belt buckles and pet collar buckles and has particular application for pet collar buckles.

2. Description of the Prior Art

Belt and collar buckles have long been known. Many conventional buckles incorporate a hoop secured to one end of a belt or strap with a capture pin pivotally connected thereto and having a free end for selective engagement in through bores formed on the opposite end of the strap. Other efforts have led to the proposal of elaborate mechanisms with housings configured with teeth or latches for engaging with slots or the like in the free end of a strap. These devices are often relatively expensive to manufacture and fail to afford more positive capture and containment of the belt or strap thus having only limited utility.

### SUMMARY OF THE INVENTION

The buckle of the present invention includes an elongated base and cover plate pivotally connected together on one extremity in clam shell fashion with the cover plate being pivotable between an open, release position, and a closed capture position when it cooperates with the base to form a passage for receipt of the opposite ends of a strap or belt disposed in overlying relationship. One end of the strap may be anchored to the base and the body of the strap encircled about a pet's neck or the like with the free extremity thereof being configured with longitudinally spaced apart capture bores to be engaged by a capture pin carried from the free extremity of the cover plate. A latch is mounted on the base and is operative to engage the cover plate and latch it in its closed position.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is a perspective view showing a buckle embodying the present invention;

FIG. 2 is an exploded view of the buckle shown in FIG. 1;

FIG. 3 is a top view, in reduced scale, of the buckle shown in FIG. 1 and depicting it receiving the free end of a dog collar strap;

FIG. 4 is a view similar to FIG. 3 but depicting the buckle anchored in place; and

FIG. 5 is a view to similar to FIG. 4 but showing the free end of the collar strap inserted in the buckle.

### DETAILED DESCRIPTION OF THE INVENTION

The elongated buckle of the present invention includes, generally, a channel shaped base 13 and overlying cover plate 15 pivotally connected together on their respective one ends and, in the closed position, cooperate together to form a passage 17 which will receive the opposite ends of a strap 19 disposed in overlying relationship as shown in FIG. 5. In the preferred embodiment, the base 13 mounts a resilient latch device, generally designated 23, and the cover 15 mounts on the free extremity thereof a pair of downwardly projecting capture pins 25 and 26 which, in the capturing position project through a pair of capture bores 29 and 30 in the free extremity of the collar strap and engage the latch 23 to latch the cover in its latching position.

In a preferred embodiment, the base 13 is channel shaped to form a bottom wall 29 and a pair of upstanding longitudinal sidewalls 31 and 33 which are formed at their respective rear extremities with rearwardly projecting tabs 35 and 37 configured with respective transverse through bores 39 and 41. The base 13 mounts near the pivot end thereof a pair of laterally spaced apart upstanding anchor posts 33 and 45.

Such base is formed at the open extremity thereof with a pair of transversely spaced apart through capture bores 51 and 53 configured for slidable receipt of the capture pins 25 and 26.

The bottom wall 29 is formed with an upwardly opening generally U-shaped channel 57 having side legs 56 and 58 disposed in alignment over the respective adjacent edges of the respective capture bores 51 and 53 in tangential relationship therewith. The width of legs 56 and 58 of the grooves expand laterally outwardly toward the open end of the buckle and the groove itself then flare laterally along respective forwardly facing angled shoulders 56 and 58 to open distally in a planer working plane 59 disposed at the level of the bottom of the groove 57. The shoulders 56 and 58 angle laterally outwardly into alignment with longitudinal distally opening grooves 63 and 65 formed at the forward end of the respective vertical sidewalls 31 and 33.

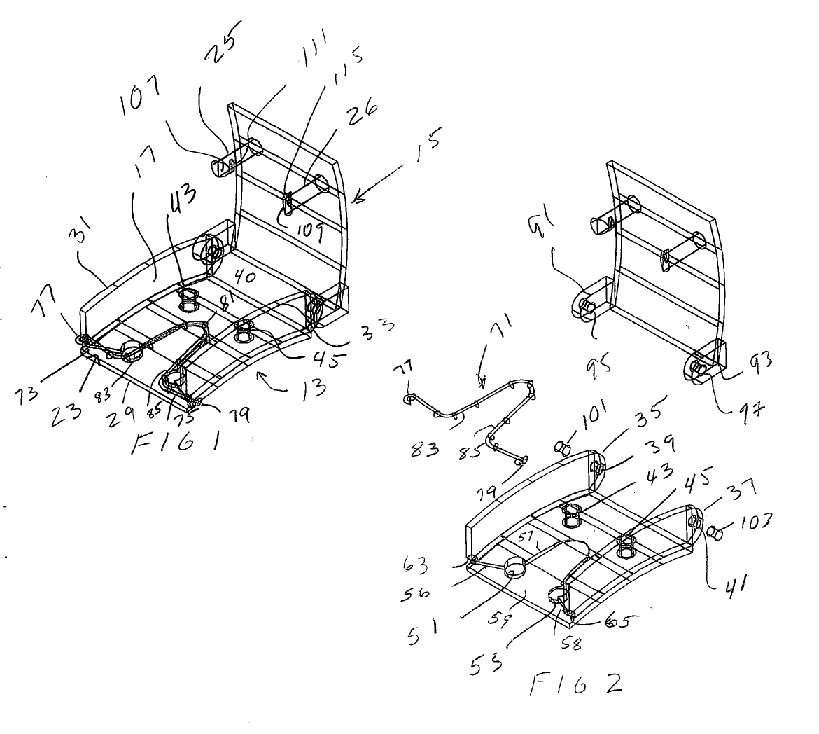

A U-shaped latch spring, generally designated 71 is nested in the groove 57 as shown in FIG. 1 and is configured at its opened end with laterally out turned wings 73 and 75 configured to project laterally outwardly in front of the respective shoulders 56 and 68 and to project laterally outwardly along the plane 59 through the respective slots 63 and 65 to be turned back on themselves to form respective thumb press loops 77 and 79. The closed end of the latch spring is anchored to the bottom wall by a track weld 81 or the like to hold such spring in place. The spring is configured such that, in its relaxed position, the free ends of its legs are biased laterally outwardly in the expanded width of the legs 56 and 58 of the groove 57 so as to dispose respective latch segments 83 and 85 in overlying relationship over the inside edges of the respective capture bores 51 and 53 (FIG. 1), just interior of the confronting tangential edges thereof.

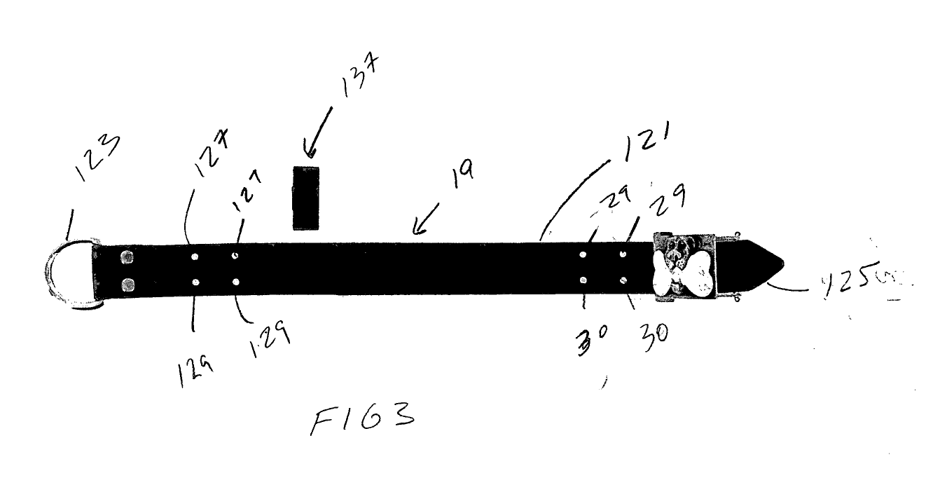

The cover plate 53 may be planar or slightly curved as depicted in FIGS. 1 and 2 and includes at its pivot end a pair of laterally spaced apart downwardly projecting pivot ears 91 and 93 overlying the tabs 35 and 37 and formed with respective axial pivot bores 95 and 97 so arranged as to be disposed, upon assembly, in overlapping relationship with the respective bores 39 and 41 for receipt of respective pivot pins 101 and 103. Such plate and the base are so configured as to, when closed define open windows 40 and 42 as the rear and front of the passage 17.

The capture pins 25 and 26 depending from the free end of the cover 15 are formed on their bottom ends with downwardly facing, upwardly and inwardly inclined cam surfaces 107 and 109, respectively, for engagement with the respective latch segments 83 and 85 of the spring 57 to, upon closure of such cover device, drive the free ends of the respective spring legs laterally inwardly to clear the path through the respective bores 51 and 53 for passage there past of the respective legs 25 and 26. The pins 25 and 26 are formed on their respective confronting sides with respective tangential inwardly facing latch grooves 111 and 115 which, when the cover 15 is closed, are engaged by the respective latch segments 83 and 85 to latch the cover in its closed position.

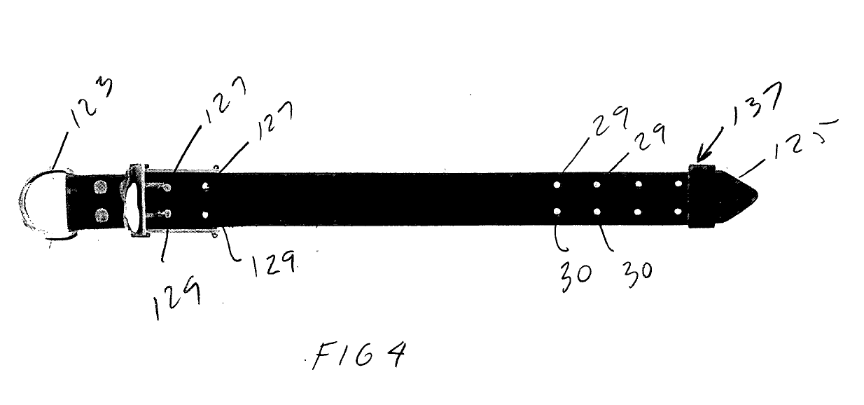

Referring to FIG. 3, the buckle of the present invention may conveniently be employed with a collar strap 121 looped at one end about a leash ring 123 and formed on its free end with a pointed tongue 125. The strap 121 is formed on its anchor end with two pair of laterally spaced apart through anchor bores 127 and 129, spaced longitudinally, configured, and arranged for selective receipt over the respective anchor posts 43 and 45. The strap 121 is formed at its free end with a plurality of pairs of longitudinally spaced, transversely spaced apart capture bores 29 and 30 so configured and spaced so that one pair may be received over the anchor posts 43 and 45 to, position the longitudinally adjacent pair in alignment over the respective capture bores 51 and 53 for receipt of the respective capture pins 107 and 109.

A strap loop, generally designated 137 is provided for capture of the free end of the strap.

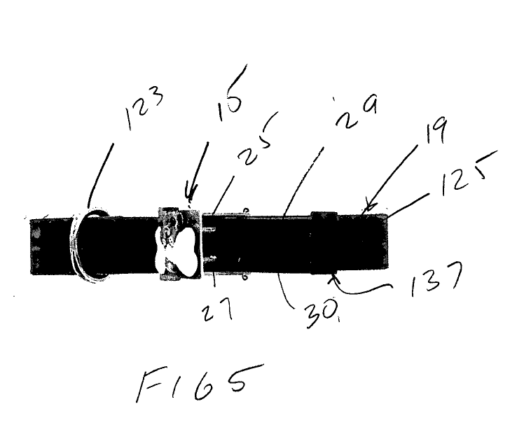

In use, it will be appreciated that the front face of the plate 15 may be decorated with, for instance, a figure of a pet, pet owner, logo of a sporting event, sport team mascot or other desired decorative elements. The strap 121 loop 137 and buckle may be sold in a package. The user can conveniently secure the strap 121 to the neck of a pet as by threading the free end of the strap 121 through the window 40 formed at the pivot end of the buckle and draw such buckle toward the leash ring 123 to the position shown in FIG. 4 to thus align the anchor posts 43 and 45 with a selected pair of anchor bores 127 and 129. Anchor posts 43 and 45 will thus be received in the selected pair of anchor bores 127 and 129, it being appreciated that such posts may be longer than the thickness of the strap 121 to leave stub ends projecting above the top surface thereof. The loop 137 may then be fed over the free end of a strap 121 as shown in FIG. 4, the body of the strap wrapped around the pets neck, through the leash ring 123 and through the window 40 in the buckle to position the free end of such strap in overlying relationship on the anchor end of the strap and to align a selected pair of the capture bores 29 and 30 over the ends of the respective anchor posts 43 and 45 to hold the strap in registration relative to the buckle so that the cover plate 15 may be pivoted to its closed position. As the cover is moved to its closed position as shown in FIG. 5, the capture pins 25 and 27 will pass through a selected pair of the capture bores 29 and 30 and downwardly through the aligned anchor bores 127 and 129 to, upon continued closure of the plate, engage the respective cam surfaces 107 and 109 at the tips of the respective pins 25 and 26 with the respective latch segments 83 and 85 (FIG. 1) such that, with continued downward movement of the free end of the cover plate, the cam surfaces will drive the legs of the spring latch segments 83 and 85 inwardly toward one another thus clearing the path way through the respective capture bores 51 and 53 allowing the pins to be inserted to the point where the grooves 111 and 115 are aligned with the respective segments 83 and 85 allowing such segments to be urged laterally outwardly there into thereby latching such cover in its closed position.

It will be appreciated that, with the cover 15 in its latch position, the stress applied to the respective posts 43 and 45 and pins 25 and 26 when tensile force is applied to the leash ring 123 is resisted primarily by the shear strength of the respective posts and pins so as to provide an extremely rugged buckle device which will resist the pull force of even the strongest pet or constrained animal. When it is desirable to unlatch the buckle, the user need merely press inwardly on the loops 77 and 79 projecting laterally from the sides of the buckle to thereby drive the free extremities of the respective legs of the spring 57 laterally inwardly toward one another to disengage the respective latch segments 83 and 85 from the grooves 111 and 115, respectively, to release the capture pins 107 and 109 such that the cover may be pivoted open and the capture end of the strap released.

It will be appreciated that the buckle and the restraint mechanism of the present invention has utility as a man or woman's belt buckle or even as a decorative buckle for clothing or the like. It will be appreciated that the panel at the front cover 15 may take many different forms and some embodiments may be replaceable.

As will be appreciated by those skilled in the art, the anchor posts and capture pins may take numerous different forms, may be in the form of single panel posts or, in some embodiments the strap may be anchored to the buckle without employing a literal post itself but, rather, a conventional retainer as well known to those skilled in the art.

I claim:

1. Clam shell pet collar apparatus comprising:
a neck strap including an anchor extremity and capture extremity, the anchor extremity being formed with at least one anchor bore and the capture extremity being formed with a plurality of capture bores;
an elongated buckle device including a base and cover plate, pivotally connected together on their respective one ends, the cover plate being pivotable from a capture position in covering relation over the base and cooperating therewith to form and elongated, through strap passage for receipt in longitudinal overlapping relation the anchor and capture extremities, to and open release position;
the base including at least one anchor post adjacent the one end thereof for selectively engaging the anchor bore;
the cover plate including at least one capture pin adjacent its free extremity to, upon closing of the cover plate to its capture position to, when the anchor and capture extremities are disposed in the passage in the overlapping relation, engage a selected one of the capture bores; and
a latch on the base, enjoyable with the cover plate to latch it in the capture position.

2. A clam shell buckle for capturing the opposite ends of a strap including an anchor extremity and a capture extremity formed with a capture bore, the buckle comprising:
an elongated base:
an elongated cover plate pivotally connected on one extremity of the base and formed on its opposite extremity with a free end;
the cover plate being pivotable from a closed position on the base cooperating therewith to form a longitudinal strap passage for receipt of the overlapping opposite extremities of the strap, to an open position;
the base including an anchor post for anchoring of one extremity of the strap thereto;
the cover plate including a latching pin on the free extremity thereof to, upon the plate being pivoted to its closed position with the strap extremities in overlying relationship in the passage, engaging the capture bore in the capture extremity of the strap; and
a latch device mounted on the base for selectively engaging the pin to latch the cover plate in its capture position.
